(19) United States
(12) Patent Application Publication
(10) Pub. No.: US 2026/0064407 A1
(43) Pub. Date: Mar. 5, 2026

(54) METHOD, APPARATUS, DEVICE AND MEDIUM FOR MANAGING CODE DATA

(71) Applicants: Lemon Inc., Grand Cayman (KY); Beijing Zitiao Network Technology Co., Ltd., Haidian District (CN)

(72) Inventors: Pengwen Jiao, Culver City, CA (US); Zihan Xiao, Beijing (CN)

(21) Appl. No.: 18/933,840

(22) Filed: Oct. 31, 2024

Related U.S. Application Data
(63) Continuation of application No. PCT/CN2024/115248, filed on Aug. 28, 2024.

(51) Int. Cl. G06F 8/71

(52) U.S. Cl. CPC G06F 8/71

(57) ABSTRACT

A method, an apparatus, a device, and a medium for managing code data are provided. In one approach, a set of merging requests is received, the set of merging requests being configured for merging first code data into second code data; in response to determining that the set of merging requests satisfy a predetermined condition, whether there is a previous merging task in execution is determined, the previous merging task being executed based on a set of previous merging requests received before the set of merging requests; and in response to determining that there is no previous merging task in execution, a merging task is executed based on the set of merging requests in order to merge a difference between the first code data and the second code data into the second code data.

### CROSS-REFERENCE

This application claims priority to Patent Application No. PCT/CN2024/115248, filed with the China National Intellectual Property Administration on Aug. 28, 2024, and entitled “METHOD, APPARATUS, DEVICE AND MEDIUM FOR MANAGING CODE DATA”, the disclosures of which are incorporated herein by reference in their entireties.

### FIELD

Example implementations of the present disclosure generally relate to application development, and in particular to a method, an apparatus, a device, and a computer-readable storage medium for managing code data in an application development.

### BACKGROUND

With continuous expansion of applications, multi-person collaborative application development has become a main way in software development. Various application development environments have been provided currently, and different developers can develop respective functional modules in the environment. In the development process, the application need to go through development, testing and publishing phases, which will result in a plurality of development branches, whereby there will be a plurality of versions of code data for a single application. At this time, merging between versions needs to be performed, so as to continuously and iteratively develop an application that more conforms to an expected function.

### SUMMARY

In a first aspect of the present disclosure, a method for managing code data is provided. In the method, a set of merging requests is received, the set of merging requests being configured for merging first code data into second code data; in response to determining that the set of merging requests satisfy a predetermined condition, whether there is a previous merging task in execution is determined, the previous merging task being executed based on a set of previous merging requests received before the set of merging requests; and in response to determining that there is no previous merging task in execution, a merging task is executed based on the set of merging requests in order to merge a difference between the first code data and the second code data into the second code data.

In a second aspect of the present disclosure, an apparatus for managing code data is provided. The apparatus comprises: a receiving module configured to receive a set of merging requests, the set of merging requests being configured for merging first code data into second code data; a determining module configured to determine, in response to determining that the set of merging requests satisfies a predetermined condition, whether there is a previous merging task in execution, the previous merging task being executed based on a set of previous merging requests received before the set of merging requests; and an executing module configured to execute, in response to determining that there is no previous merging task in execution, a merging task based on the set of merging requests to merge a difference between the first code data and the second code data to the second code data.

In a third aspect of the present disclosure, an electronic device is provided. The electronic device comprises: at least one processing unit; and at least one memory coupled to the at least one processing unit and storing instructions for execution by the at least one processing unit, the instructions, when executed by the at least one processing unit, causing the electronic device to perform the method according to the first aspect of the present disclosure.

In a fourth aspect of the present disclosure, there is provided a computer-readable storage medium having stored thereon a computer program which, when executed by a processor, causes the processor to implement the method according to the first aspect of the present disclosure.

In a fifth aspect of the present disclosure, there is provided a computer program product, comprising a computer program, wherein the computer program, when executed by a processor, implements the method according to the first aspect of the present disclosure.

It should be understood that the content described in this section is not intended to limit key features or important features of implementations of the present disclosure, nor is it intended to limit the scope of the present disclosure. Other features of the present disclosure will become readily understood from the following description.

### BRIEF DESCRIPTION OF DRAWINGS

Hereinafter, the above and other features, advantages, and aspects of various implementations of the present disclosure will become more apparent with reference to the following detailed description taken in conjunction with the accompanying drawings. In the drawings, identical or similar reference numbers denote identical or similar elements, where:

FIG. 1 is a block diagram illustrating an application environment according to an example implementation of the present disclosure;

FIG. 2 illustrates a block diagram for managing code data according to some implementations of the present disclosure;

FIG. 3 is a block diagram illustrating a merging condition according to some implementations of the present disclosure;

FIG. 4 is a block diagram illustrating a process for creating a merging task according to some implementations of the present disclosure;

FIG. 5 is a block diagram illustrating functions of a plurality of modules for managing code data according to some implementations of the present disclosure;

FIG. 6 is a block diagram illustrating a method for managing code data according to some implementations of the present disclosure;

FIG. 7 is a block diagram illustrating an apparatus for managing code data according to some implementations of the present disclosure; and

FIG. 8 is a block diagram illustrating a device capable of implementing various implementations of the present disclosure.

### DETAILED DESCRIPTION

Implementations of the present disclosure will be described in more detail below with reference to the accompanying drawings. While certain implementations of the present disclosure are shown in the drawings, it should be understood that the present disclosure may be implemented in various forms and should not be construed as limited to the implementations set forth herein; rather, these implementations are provided for a thorough and complete understanding of the present disclosure. It should be understood that the drawings and implementations of the present disclosure are only for exemplary purposes and are not intended to limit the scope of protection of the present disclosure.

In the description of implementations of the present disclosure, the term “comprising” and its similar words should be understood as open-ended including, that is, “comprising but not limited to”. The term “based on” should be read as “based at least in part on”. The term “one implementation” or “the implementation” should be read as “at least one implementation”. The term “some implementations” should be understood as “at least some implementations”. Other explicit and implicit definitions may also be included below. As used herein, the term “model” may denote an association relationship between respective data. The association relationship may be obtained, for example, based on a variety of technical solutions that are currently known and/or will be developed in the future.

It is to be understood that the data involved in the technical solution (including but not limited to the data itself, the acquisition or use of the data) should comply with the requirements of the corresponding legal regulations and related provisions.

It should be understood that, before the technical solutions disclosed in the embodiments of the present disclosure are used, the user should be informed of the type of the personal information, the usage range, the usage scenario, and the like related to the present disclosure and the authorization of the user should be obtained in an appropriate manner according to relevant legal regulations.

For example, in response to receiving an active request from a user, prompt information is sent to the user to explicitly prompt the user that an operation requested by the user will require acquisition and use of personal information of the user. Thus, the user can autonomously select, according to the prompt information, whether to provide personal information to software or hardware such as an electronic device, an application program, a server, or a storage medium that executes the operations of the technical solutions of the present disclosure.

As an optional but non-limiting implementation, a manner of sending prompt information to a user in response to receiving an active request from the user may be, for example, a manner of popping up a window, and the prompt information may be presented in a text manner in the pop-up window. In addition, the pop-up window may also carry a selection control for the user to select “agree” or “don't agree” to provide personal information to the electronic device.

It can be understood that, the above processes of notifying and obtaining the user authorization are only illustrative, and do not limit the implementation of the present disclosure, and other methods meeting relevant legal regulations may also be applied to the implementation of the present disclosure.

As used herein, the term “in response to” refers to a state in which a corresponding event occurs or a condition is satisfied. It will be appreciated that the execution timing for a subsequent action that is executed in response to the event or condition is not necessarily strongly correlated with the time when the event or condition occurs or is satisfied. For example, in some cases, subsequent actions may be performed immediately upon occurrence of an event or upon satisfaction of a condition; in some other cases, subsequent actions may be performed only after a period of time has elapsed since an event occurs or a condition is satisfied.

### Example Environment

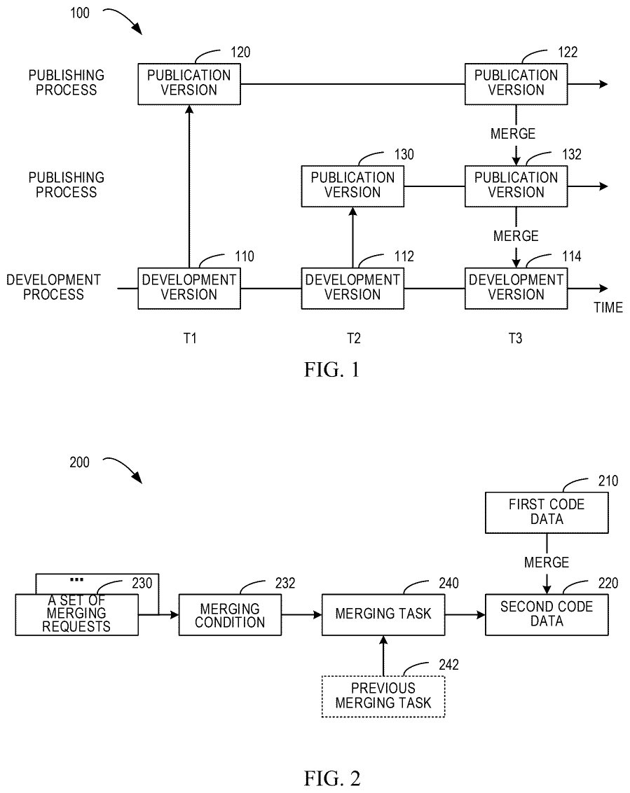

Various application development environments have been provided currently, and different developers can develop respective functional modules in the environments. In the development process, the application need to go through development, testing and publishing phases, which will result in a plurality of development branches, whereby there will be a plurality of versions of code data for a single application. Referring to FIG. 1 to describe an application environment according to some implementations of the present disclosure, and FIG. 1 illustrates a block diagram 100 of an application environment according to an example implementation of the present disclosure.

As shown in FIG. 1, for a specific application, there may be a plurality of development versions in the development process. For example, there may be a development version 110 at time point T1, a publication version 120 may be generated based on the development version 110, and the publication version may go through testing and form a new publication version 122. In another example, as the development process proceeds, there may be a development version 112 at time point T2, a publication version 130 may be generated based on the development version 112, and the publication version 130 may go through testing and form a new publication version 132. There will be a plurality of versions of code data at time point T3: the publication version 122, the publication version 132, and a development version 114.

The publication versions 122 and 132 have gone through respective testing processes, thereby potential errors are eliminated, and at the same time, the development version 114 has gone through a development process and has new functionality in addition to those of the publication versions 122 and 132. At this point, the publication version 122 needs to be merged into the publication version 132, and the publication version 122 needs to be merged into the publication version 132. At this time, merging between versions needs to be performed, thereby continuously and iteratively developing an application that more conforms to an expected function.

Although a development environment supporting multi-person parallel development, testing and publishing has been proposed, manual management of an administrator is required in the process of merging code data. For example, manual merge operations are performed at long intervals (typically 1 time per day, or with other frequencies), at this time, a large number of code changes have been generally accumulated, thus a code conflict likely exists during the merging, and it takes a long time for having changes made on the old version to be reflected on the new version.

Further, the synchronization task state between versions is not clear, and it is impossible to determine whether the publication version 132 already includes all updates of the publication version 122 when the publication version 132 is published. Meanwhile, the efficiency of solving code conflict manually is low, resulting in manpower waste, and the potential risks in the code data merging process may be caused. At this point, it is desirable to manage code data in a more efficient and reliable manner.

### Summary of Code Data Management

In order to at least partially solve the deficiencies in the prior art, according to an example implementation of the present disclosure, a method for managing code data is provided. Referring to FIG. 2 to describe a summary according to an example implementation of the present disclosure, and FIG. 2 illustrates a block diagram 200 for managing code data according to some implementations of the present disclosure.

As shown in FIG. 2, there may be first code data 210 and second code data 220. A set of merging requests 230 may be received. Here, the set of merging requests 230 is configured to merge the first code data into the second code data. It may be determined that the set of merging requests satisfying a predetermined condition (e.g., merging condition 232). In response to determining that the set of merging requests 230 satisfy the predetermined condition, it is determined whether there is a previous merging task 242 in execution. Here, the previous merging task 242 is executed based on a set of previous merging requests received before the current set of merging requests.

If the previous merging task 242 has been completed, there is no previous merging task 242 in execution. If the previous merging task 242 has not been completed, there is a previous merging task 242 in execution, and it is necessary to wait for the execution of the previous merging task 242 being completed before starting the current merging task 240. In response to determining that there is no previous merging task in execution, the merging task 240 is executed based on the set of merging requests in order to merge the difference between the first code data 210 and the second code data into the second code data 220.

According to example implementations of the present disclosure, a corresponding merging condition may be specified according to a specific application development requirement, and a merging task is automatically executed based on a currently received set of merging requests when the merging condition is satisfied. In this way, the complexity of manual operation in the development process can be greatly reduced, and the potential risks caused by human errors can be reduced, thereby improving the development efficiency.

### Detailed Procedure for Code Data Management

A summary in accordance with some implementations of the present disclosure has been described with reference to FIG. 2, in which more information about code data management is described below with reference to the drawings. According to some implementations of the present disclosure, the first code data and the second code data include source codes associated with an application, the first code data includes any one of a submission version and a test version of the source codes, and the second code data includes a development version of the source codes. Specifically, the code data in each branch in the application development phase may be automatically processed. For example, the tested and/or published code data may be merged into a subsequent development version, thereby synchronizing the optimized code data in the test version and the publication version into the development version on the basis of performing development, testing and publishing in parallel.

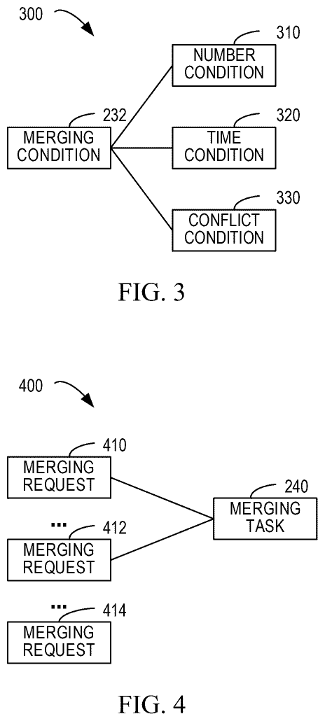

FIG. 3 illustrates a block diagram 300 of a merging condition in accordance with some implementations of the present disclosure. As shown in FIG. 3, a corresponding merging condition 232 may be specified according to a specific application development requirement, and the merging condition 232 may include a number condition 310, a time condition 320, and a conflict condition 330.

In accordance with some implementations of the present disclosure, the number condition 310 may specify whether a number of the set of merging requests exceeding a threshold number. Generally, the larger the number of merging requests, the larger the amount of code involved in the merging process and the higher the probability of causing a potential conflict. At this point, an appropriate threshold number may be specified (e.g., 5 or other number).

When the number of received merging requests is greater than or equal to 5, the merging process is started; and when the number of received merging requests is less than 5, a subsequent merging request may be awaited. Since the merging process will result in extra resource overhead, performing the merging process too frequently may increase the workload of the development environment. In this way, a balance can be found between resource overheads and conflict probability, thereby improving overall development efficiency. Specifically, the threshold number may be determined based on the receiving frequency of receipt of the merging request, and the lower the frequency is, the smaller the threshold number is. In this way, long wait for the next merging process can be avoided, and merge efficiency can be improved.

The time condition 320 may specify whether a time difference between the current time and the execution time of the previous merging task exceeds a threshold time difference. For example, it may be specified that the merging process is executed once every hour, that is, if the time difference exceeds one hour, the merging process is executed based on the merging request that has been received currently. It should be understood that, if the receiving frequency of the merging request is lower, a new merging request may not be received for long time, which results in the number of merging requests failing to satisfy the number condition 310 for long time, and then the merging cannot be performed. At this time, the time condition 320 may increase the execution frequency of the merging process to some extent, thereby ensuring that the modification to the code data may be synchronized to the development version in time.

The conflict condition 330 may specify whether there is third code data to be merged into the second code data, where a code conflict exists between the first code data and the third code data. The merging process may be started without a conflict.

According to some implementations of the present disclosure, the average number of lines for determining code differences according to the merging condition 232 described above is approximately 300, and the determined variance of the number of code lines is better than the average value as compared to the technical solution in which the merging process is performed conventionally by timing. In this way, the stability of the merging process can be improved. Further, the number of code lines directly affects the success rate and the conflict rate of the merge pipeline. In this way, it may be ensured that a small-scale synchronization task is executed each time, and the code conflict rate and execution failure rate may be greatly reduced, e.g., to 5% or even lower.

According to some implementations of the present disclosure, the merging task 240 may include one or more merging requests. Further details are described with reference to FIG. 4, which illustrates a block diagram 400 of a process for creating a merging task according to some implementations of the present disclosure. If the merging process is started based on the number condition 310, the merging task 240 may include a threshold number of merging requests, such as 410, . . . , 412. As another example, if the merging process is started according to the time condition 320, the merging task 240 may include a number (less than a threshold number) of merging requests, e.g., including only a single merging request 414.

According to some implementations of the present disclosure, a synchronization pipeline may be triggered to execute a merging task. Each merging request may be processed in a similar manner, such as, for a first merging request in a set of merging requests, a first code portion in the first code data corresponds to the first merging request, and a second code portion in the second code data corresponds to the first merging request may be determined; a first difference between the first code portion and the second code portion is determined; and in response to determining that the first difference passes a code checking process, the first difference is merged into the second code portion of the second code data.

Specifically, differences between code data may be determined, for example, two code portions with a difference therebetween may be found, and the difference between the two code portions may be determined. A pipeline may be started to perform code checking for the difference portion in order to ensure that the merged code data does not cause an exception. With example implementations of the present disclosure, it can be ensured that the merged code data passes the code checking process, thereby ensuring that the merged second code data can achieve a desired function.

According to some implementations of the present disclosure, the code checking process may include a plurality of aspects. For example, a building checking process may be performed to determine whether the merged second code data is successfully built. For example, temporary code data may be created to save the result of merging the first code portion into the second code portion, a building operation may be performed for the temporary code data, and if the building is successful, it indicates that the building checking is passed; otherwise, it indicates that the building checking is failed.

Alternatively and/or additionally, the code checking process may include a stability check process configured to determine whether the merged second code data passes a stability test. Herein, the stability test can ensure that the merged code data can generate stable running results, thereby ensuring the quality of the merged code data. Further, the code checking process may include a security check process configured to determine whether the merged second code data passes a security test, thereby ensuring that the merged code data will not cause a data security risk.

According to some implementations of the present disclosure, if it is determined that the first difference passes the code checking process, it indicates that the merging process does not cause a potential risk, and thus the first merging request may be executed. Alternatively and/or additionally, if it is determined that the first difference does not pass the code checking process, it indicates that a direct execution of the merging process may cause a potential risk, thus requiring subsequent manual processing. At this time, the prompt information may be provided to at least any of: a submitter of the first merging request, and an administrator for managing code data merging.

Specifically, a submission history of the merging request may be queried in order to determine a submitter of a relevant merging request, an administrator for supervising the merging process may be determined, and prompt information is provided to the submitter and/or the administrator, and the submitter and/or the administrator may be notified that the relevant code data of the merging request failed the code checking process. With example implementations of the present disclosure, relevant person(s) may be notified in time to resolve potential risks in code data, thereby improving development efficiency.

According to some implementations of the present disclosure, it may be checked whether a code conflict occur between code requests. Specifically, for a second merging request in the set of merging requests, it is determined whether there is a code conflict between the first code part and a third code part in the first code data corresponding to the second merging request. Further, in response to determining that there is a code conflict between the first code portion and the third code portion, prompt information is provided to at least any of: a first submitter of the first merging request, and a second submitter of the second merging request. Specifically, the submission histories of respective merging requests may be queried to determine one or more submitters of the related merging request, thereby providing prompt information.

With example implementations of the present disclosure, the prompt information may include, for example, related information of the merging request, such as, an identifier of the merging request, a submission time, a specific position of the involved code segment, and related descriptions, and the like. In this way, each submitter may be supported to quickly find the position of the code that lead to the conflict, thereby correcting potential errors in the code.

According to some implementations of the present disclosure, the first submitter and the second submitter are determined separately based on the first submission history of the first merging request and the second submission history of the second merging request. A communication group is established based on the first submitter and the second submitter, and prompt information is provided in the communication group. In a case that a code conflict involves a plurality of submitters, a group may be established for the plurality of submitters to support the plurality of submitters to discuss problems in the group and eliminating the code conflict. For example, the code data may be adjusted and the first merging request is updated based on the adjusted code data. According to some implementations of the present disclosure, in response to determining that a code conflict has been resolved, an updated first merging request is executed. At this time, the code conflict can be eliminated in time, and the development efficiency is improved.

According to some implementations of the present disclosure, in response to determining that there is no code conflict between the first code portion and the third code portion, the second merging request may be directly executed. With the example implementation of the present disclosure, it may be ensured that the second merging request does not incur code conflict, thereby ensuring stability of the merging process.

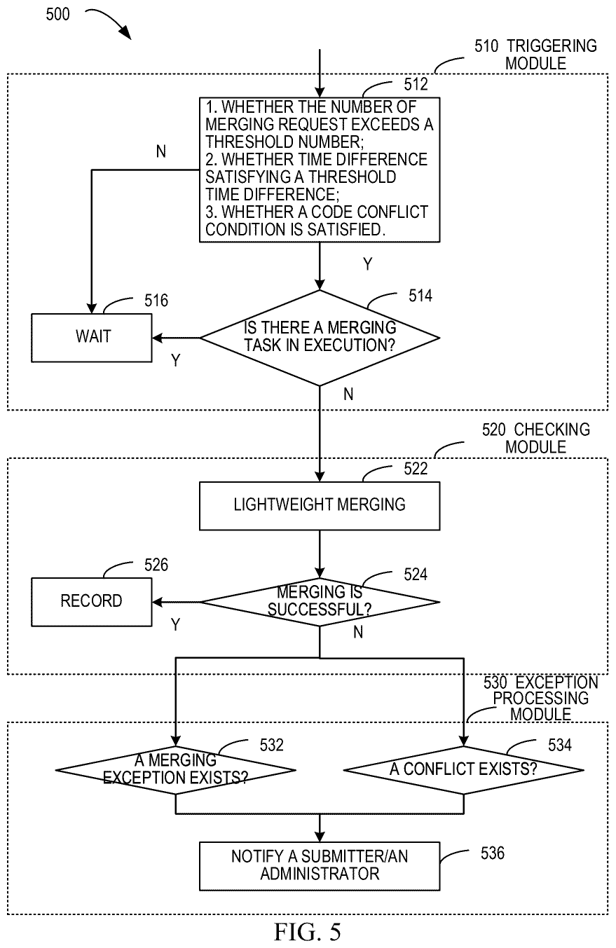

Various steps in the process of merging code data have been described above, and in the following, referring to FIG. 5, an overall process for merging code data is described. FIG. 5 is a block diagram 500 illustrating functions of a plurality of modules for managing code data according to some implementations of the present disclosure. As shown in FIG. 5, a triggering module 510, a checking module 520, and an exception processing module 530 may be called to perform the processes described above.

At block 512, the triggering module 510 may determine whether the received set of merging requests satisfy a predetermined merging condition. In response to the set of merging requests satisfying the merging condition, the flow may proceed to block 514 to determine if there is a previous merging task in execution. In response to determining that the result is “Yes”, the current flow may be paused to wait for the execution of the previous merging task being completed at block 516. In response to determining that the result is “No”, the checking module 520 may be called to perform further processing.

At block 522, a lightweight merging may be performed. Specifically, a corresponding merging operation may be performed based on each merging request. At block 524, if the merging is successful, log information about successful execution may be recorded, at block 526. If the merging fails, the exception processing module 530 may be called to perform subsequent exception processing.

Specifically, at block 532, it may be determined whether there is a merging exception; at block 534, it may be determined whether there is a code conflict. When an exception and/or conflict occurs, relevant information of the submitter of the corresponding merging request and/or the administrator of the merge system may be queried. Further, the relevant submitter and/or administrator may be notified at block 536. In this way, the communication group can be established for personnel involved in exception processing, so that each person can communicate in time and the exception is eliminated.

According to example implementations of the present disclosure, a corresponding merging condition may be specified according to a specific application development requirement, and when the merging condition is satisfied, a merging task is automatically executed based on a currently received set of merging requests. In this way, the complexity of manual operation in the development process can be greatly reduced, and the potential risks caused by human errors can be reduced, thereby improving the development efficiency.

### Example Processes

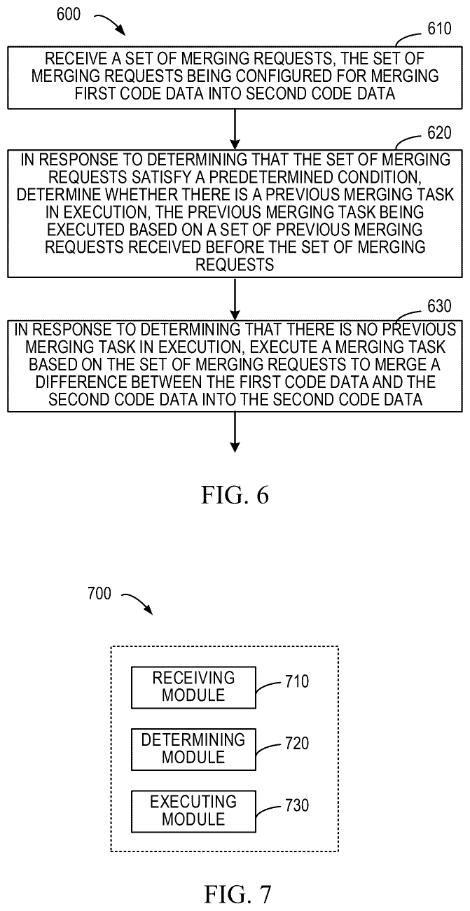

FIG. 6 illustrates a flowchart of a method 600 for managing code data according to some implementations of the present disclosure. At block 610, a set of merging requests are received, the set of merging requests being configured merging the first code data to the second code data; at block 620, in response to determining that the set of merging requests satisfy a predetermined condition, whether there is a previous merging task in execution is determined, the previous merging task being executed based on a set of previous merging requests received before the set of merging requests; and at block 630, in response to determining that there is no previous merging task in execution, a merging task is executed based on the set of merging requests in order to merge the difference between the first code data and the second code data to the second code data.

According to some implementations of the present disclosure, the predetermined condition comprises at least any of: whether a number of the set of merging requests exceeds a threshold number; whether a time difference between a current time and an execution time of the previous merging task exceeds a threshold time difference; and whether there is third code data to be merged into the second code data, where a code conflict exists between the first code data and the third code data.

According to some implementations of the present disclosure, executing the merging task comprises: for a first merging request in a set of merging requests, determining a first code portion in the first code data corresponding to the first merging request and a second code portion in the second code data corresponding to the first merging request; determining a first difference between the first code portion and the second code portion; and in response to determining that the first difference passes a code checking process, merging the first difference into the second code portion of the second code data.

According to some implementations of the present disclosure, the code checking process comprises at least any of: a building checking process configured to determine whether the merged second code data is successfully built; a stability checking process configured to determine whether the merged second code data passes a stability test; and a security checking process configured to determine whether the merged second code data passes a security test.

According to some implementations of the present disclosure, the method further comprises at least any of: in response to determining that the first difference passes the code checking process, executing the first merging request; and in response to determining that the first difference fails the code checking process, providing prompt information to at least any of: a submitter of the first merging request and an administrator for managing code data merging.

According to some implementations of the present disclosure, the method further comprises: with regard to a second merging request in the set of merging requests, determining whether there is a code conflict between the first code portion and a third code portion in the first code data corresponding to the second merging request; and in response to determining that there is a code conflict between the first code portion and the third code portion, providing prompt information to at least any of a first submitter of the first merging request, and a second submitter of the second merging request.

According to some implementations of the present disclosure, the method further comprises: determining the first submitter and the second submitter respectively based on a first submission history of the first merging request and a second submission history of the second merging request; establishing a communication group based on the first submitter and the second submitter; and providing the prompt information in the communication group.

According to some implementations of the present disclosure, the method further comprises: in response to determining that the code conflict has been resolved, executing an updated first merging request.

According to some implementations of the present disclosure, the method further comprises: in response to determining that there is no code conflict between the first code portion and the third code portion, executing the first merging request.

According to some implementations of the present disclosure, the first code data and the second code data comprise source codes associated with an application, the first code data comprises any one of a submission version and a test version of the source codes, and the second code data comprises a development version of the source codes.

### Example Apparatus and Device

FIG. 7 illustrates a block diagram of an apparatus 700 for managing code data according to some implementations of the present disclosure. The apparatus comprises: a receiving module 710 configured to receive a set of merging requests, the set of merging requests being configured for merging first code data into second code data; a determining module 720 configured to determine, in response to determining that the set of merging requests satisfies a predetermined condition, whether there is a previous merging task in execution, the previous merging task being executed based on a set of previous merging requests received before the set of merging requests; and an executing module 730 configured to execute, in response to determining that there is no previous merging task in execution, a merging task based on the set of merging requests to merge a difference between the first code data and the second code data to the second code data.

According to some implementations of the present disclosure, the predetermined condition comprises at least any of: whether a number of the set of merging requests exceeds a threshold number; whether a time difference between a current time and an execution time of the previous merging task exceeds a threshold time difference; and whether there is third code data to be merged into the second code data, where a code conflict exists between the first code data and the third code data.

According to some implementations of the present disclosure, the executing module comprises: a code determining module configured to determine, for a first merging request in the set of merging requests, a first code portion in the first code data corresponding to the first merging request and a second code portion in the second code data corresponding to the first merging request; a difference determining module configured to determine a first difference between the first code part and the second code part; and a merging module configured to merge, in response to determining that the first difference passes a code checking process, the first difference into the second code portion of the second code data.

According to some implementations of the present disclosure, the code checking process comprises at least any of: a building checking process configured to determine whether the merged second code data is successfully built; a stability checking process configured to determine whether the merged second code data passes a stability test; and a security checking process configured to determine whether the merged second code data passes a security test.

According to some implementations of the present disclosure, the apparatus further comprises at least any of: a request executing module configured to execute, in response to determining that the first difference passes the code checking process, the first merging request; and a providing module configured to provide, in response to determining that the first difference fails the code checking process, provide prompt information to at least any of: a submitter of the first merging request and an administrator for managing code data merging.

According to some implementations of the present disclosure, the apparatus further comprises: a conflict determining module configured to determine, for a second merging request in the set of merging requests, whether there is a code conflict between the first code portion and a third code portion in the first code data corresponding to the second merging request; and a providing module configured to provide, in response to determining that there is a code conflict between the first code portion and the third code portion, prompt information to at least any of a first submitter of the first merging request, and a second submitter of the second merging request.

According to some implementations of the present disclosure, the apparatus further comprises: a submitter determining module configured to determine the first submitter and the second submitter respectively based on a first submission history of the first merging request and a second submission history of the second merging request; an establishing module configured to establish a communication group based on the first submitter and the second submitter; and an information providing module configured to provide the prompt information in the communication group.

According to some implementations of the present disclosure, the apparatus further comprises: a request executing module configured to execute the updated first merging request in response to determining that the code conflict has been resolved.

According to some implementations of the present disclosure, the apparatus further comprises: a request executing module configured to execute the first merging request in response to determining that there is no code conflict between the first code portion and the third code portion.

According to some implementations of the present disclosure, the first code data and the second code data comprise source codes associated with an application, the first code data comprises any one of a submission version and a test version of the source codes, and the second code data comprises a development version of the source codes.

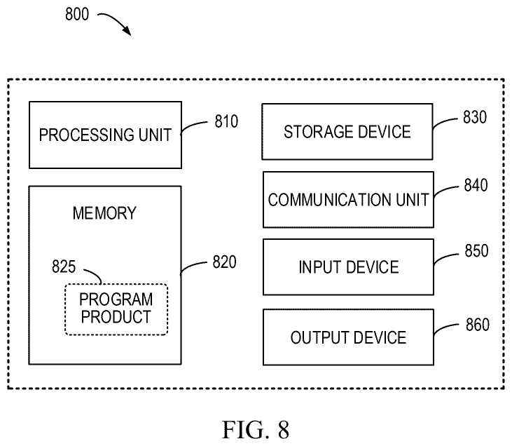

FIG. 8 illustrates a block diagram of a device 800 capable of implementing various implementations of the present disclosure. It should be understood that the computing device 800 shown in FIG. 8 is merely an example and should not constitute any limitation on the functionality and scope of the implementations described herein. The computing device 800 shown in FIG. 8 may be configured to implement the method described above.

As shown in FIG. 8, the computing device 800 is in the form of a general-purpose computing device. Components of the computing device 800 may include, but are not limited to, one or more processors or processing units 810, a memory 820, a storage device 830, one or more communications units 840, one or more input devices 850, and one or more output devices 860. The processing unit 810 may be an actual or virtual processor and can perform various processes according to programs stored in the memory 820. In a multiprocessor system, a plurality of processing units execute computer executable instructions in parallel, so as to improve the parallel processing capability of the computing device 800.

The computing device 800 typically includes a number of computer storage media. Such media may be any available media that are accessible by the computing device 800, including, but not limited to, volatile and non-volatile media, removable and non-removable media. The memory 820 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 830 may be a removable or non-removable medium and may include a machine-readable medium such as a flash drive, a magnetic disk, or any other medium that can be used to store information and/or data (such as training data used for training) and that can be accessed within the computing device 800.

The computing device 800 may further include additional removable/non-removable, volatile/nonvolatile storage media. Although not shown in FIG. 8, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 820 may include a computer program product 825 having one or more program modules configured to perform various methods or actions of various implementations of the present disclosure.

The communication unit 840 implements communication with other computing devices through a communication medium. In addition, functions of components of the computing device 800 may be implemented by a single computing cluster or a plurality of computing machines, and these computing machines can communicate through a communication connection. Thus, the computing device 800 may operate in a networked environment using logical connections to one or more other servers, network personal computers (PCs), or another network node.

The input device 850 may be one or more input devices such as a mouse, keyboard, trackball, etc. The output device 860 may be one or more output devices such as a display, speaker, printer, etc. The computing device 800 may also communicate with one or more external devices (not shown) such as a storage device, a display device, or the like through the communication unit 840 as required, and communicate with one or more devices that enable a user to interact with the computing device 800, or communicate with any device (e.g., a network card, a modem, or the like) that enables the computing device 800 to communicate with one or more other computing devices. Such communication may be performed via an input/output (I/O) interface (not shown).

According to an example implementation of the present disclosure, a computer readable storage medium is provided, on which a computer-executable instruction is stored, where the computer executable instruction is executed by a processor to implement the above-described method. According to an example implementation of the present disclosure, there is also provided a computer program product, which is tangibly stored on a non-transitory computer readable medium and includes computer-executable instructions that are executed by a processor to implement the method described above. According to an example implementation of the present disclosure, there is provided a computer program product having a computer program stored thereon, the program implement the methods described above when being executed by a processor.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

I/We claim:

1. A method for managing code data, comprising:
receiving a set of merging requests, the set of merging requests being configured for merging first code data into second code data;
in response to determining that the set of merging requests satisfy a predetermined condition, determining whether there is a previous merging task in execution, the previous merging task being executed based on a set of previous merging requests received before the set of merging requests; and
in response to determining that there is no previous merging task in execution, executing a merging task based on the set of merging requests to merge a difference between the first code data and the second code data into the second code data.

2. The method of claim 1, wherein the predetermined condition comprises at least one of:
whether a number of the set of merging requests exceeds a threshold number;
whether a time difference between a current time and an execution time of the previous merging task exceeds a threshold time difference; and
whether there is third code data to be merged into the second code data, a code conflict exists between the first code data and the third code data.

3. The method of claim 1, wherein executing the merging task comprises: for a first merging request in the set of merging requests,
determining a first code portion in the first code data corresponding to the first merging request and a second code portion in the second code data corresponding to the first merging request;
determining a first difference between the first code portion and the second code portion; and
in response to determining that the first difference passes a code checking process, merging the first difference into the second code portion of the second code data.

4. The method of claim 3, wherein the code checking process comprises at least any of:
a building checking process configured to determine whether the merged second code data is successfully built;
a stability checking process configured to determine whether the merged second code data passes a stability test; and
a security checking process configured to determine whether the merged second code data passes a security test.

5. The method of claim 3, further comprising at least any of:
in response to determining that the first difference passes the code checking process, executing the first merging request; and
in response to determining that the first difference fails the code checking process, providing prompt information to at least any of: a submitter of the first merging request and an administrator for managing code data merging.

6. The method of claim 3, further comprising:
with regard to a second merging request in the set of merging requests, determining whether there is a code conflict between the first code portion and a third code portion in the first code data corresponding to the second merging request; and
in response to determining that there is a code conflict between the first code portion and the third code portion, providing prompt information to at least any of a first submitter of the first merging request, and a second submitter of the second merging request.

7. The method of claim 6, further comprising:
determining the first submitter and the second submitter respectively based on a first submission history of the first merging request and a second submission history of the second merging request;
establishing a communication group based on the first submitter and the second submitter; and
providing the prompt information in the communication group.

8. The method of claim 6, further comprising: in response to determining that the code conflict has been resolved, executing an updated first merging request.

9. The method of claim 1, further comprising: in response to determining that there is no code conflict between the first code portion and the third code portion, executing the first merging request.

10. The method of claim 1, wherein the first code data and the second code data comprise source codes associated with an application, the first code data comprises any one of a submission version and a test version of the source codes, and the second code data comprises a development version of the source codes.

11. An electronic device, comprising:
at least one processing unit; and
at least one memory coupled to the at least one processing unit and storing instructions for execution by the at least one processing unit, the instructions, when executed by the at least one processing unit, causing the electronic device to perform a method for managing code data, the method comprising:
receiving a set of merging requests, the set of merging requests being configured for merging first code data into second code data;
in response to determining that the set of merging requests satisfy a predetermined condition, determining whether there is a previous merging task in execution, the previous merging task being executed based on a set of previous merging requests received before the set of merging requests; and
in response to determining that there is no previous merging task in execution, executing a merging task based on the set of merging requests to merge a difference between the first code data and the second code data into the second code data.

12. The device of claim 11, wherein the predetermined condition comprises at least one of:
whether a number of the set of merging requests exceeds a threshold number;
whether a time difference between a current time and an execution time of the previous merging task exceeds a threshold time difference; and
whether there is third code data to be merged into the second code data, a code conflict exists between the first code data and the third code data.

13. The device of claim 11, wherein executing the merging task comprises: for a first merging request in the set of merging requests,
determining a first code portion in the first code data corresponding to the first merging request and a second code portion in the second code data corresponding to the first merging request;
determining a first difference between the first code portion and the second code portion; and
in response to determining that the first difference passes a code checking process, merging the first difference into the second code portion of the second code data.

14. The device of claim 13, wherein the code checking process comprises at least any of:
a building checking process configured to determine whether the merged second code data is successfully built;
a stability checking process configured to determine whether the merged second code data passes a stability test; and
a security checking process configured to determine whether the merged second code data passes a security test.

15. The device of claim 13, further comprising at least any of:
in response to determining that the first difference passes the code checking process, executing the first merging request; and
in response to determining that the first difference fails the code checking process, providing prompt information to at least any of: a submitter of the first merging request and an administrator for managing code data merging.

16. The device of claim 13, further comprising:
with regard to a second merging request in the set of merging requests, determining whether there is a code conflict between the first code portion and a third code portion in the first code data corresponding to the second merging request; and
in response to determining that there is a code conflict between the first code portion and the third code portion, providing prompt information to at least any of a first submitter of the first merging request, and a second submitter of the second merging request.

17. The device of claim 16, further comprising:
determining the first submitter and the second submitter respectively based on a first submission history of the first merging request and a second submission history of the second merging request;
establishing a communication group based on the first submitter and the second submitter; and
providing the prompt information in the communication group.

18. The device of claim 16, further comprising any of:
in response to determining that the code conflict has been resolved, executing an updated first merging request; and
in response to determining that there is no code conflict between the first code portion and the third code portion, executing the first merging request.

19. The device of claim 11, wherein the first code data and the second code data comprise source codes associated with an application, the first code data comprises any one of a submission version and a test version of the source codes, and the second code data comprises a development version of the source codes.

20. A non-transitory computer-readable storage medium having stored thereon a computer program which, when executed by a processor, causes the processor to implement a method for managing code data, the method comprising:
receiving a set of merging requests, the set of merging requests being configured for merging first code data into second code data;
in response to determining that the set of merging requests satisfy a predetermined condition, determining whether there is a previous merging task in execution, the previous merging task being executed based on a set of previous merging requests received before the set of merging requests; and
in response to determining that there is no previous merging task in execution, executing a merging task based on the set of merging requests to merge a difference between the first code data and the second code data into the second code data.
